(19) United States
(12) Patent Application Publication
(10) Pub. No.: US 2025/0279104 A1
(43) Pub. Date: Sep. 4, 2025

(54) Adaptive Ambisonics Compression

(71) Applicant: Samsung Electronics Co., Ltd., Suwon-si (KR)

(72) Inventors: Mahmoud Namazi, Santa Clarita, CA (US); Toni Hirvonen, Santa Clarita, CA (US); Sunil Bharitkar, Stevenson Ranch, CA (US)

(21) Appl. No.: 18/942,767

(22) Filed: Nov. 10, 2024

Related U.S. Application Data
(60) Provisional application No. 63/560,578, filed on Mar. 1, 2024.

(51) Int. Cl. G10L 19/008; G10L 19/18

(52) U.S. Cl. CPC G10L 19/008; G10L 19/18

(57) ABSTRACT

In one embodiment, a method includes accessing a set of Ambisonics data encoding an audio signal and including multiple Ambisonics channels. The method further includes applying a singular value decomposition transform to the set of Ambisonics data to decorrelate the Ambisonics channels; determining, for each decorrelated Ambisonics channel, a relative energy of that decorrelated Ambisonics channel, based on the decorrelating singular value decomposition transform; and determining, for each decorrelated Ambisonics channel, an allocated bitrate from an available bitrate, where the allocated bitrate is based on the relative energy of the respective decorrelated Ambisonics channel; and encoding each decorrelated Ambisonics channel according to the allocated bitrate.

### PRIORITY CLAIM

This application claims the benefit under 35 U.S.C. § 119 of U.S. Provisional Patent Application No. 63/560,578 filed Mar. 1, 2024, which is incorporated by reference herein.

### TECHNICAL FIELD

This application generally relates to adaptive ambisonics compression.

### BACKGROUND

Ambisonics is a form of immersive spatial audio encoding that models audio as a three-dimensional sound field, in contrast to encoding techniques that assign audio to particular channels that correspond to particular speakers. For example, an entertainment system may include a pair of left-right stereo loudspeakers, a subwoofer, a center loudspeaker, a pair of left-right surround loudspeakers, and/or a pair of left-right rear surround loudspeakers. The number of loudspeakers in a system are often referred to by an x·y convention, where x is the number of loudspeakers used in the system and y refers to the number of subwoofers used in the system. In channel-based encoding techniques, audio is specifically assigned to each of the x+y channels, and the speaker(s) that correspond to a particular channel play audio assigned to that channel.

In contrast, Ambisonics treats an audio as being a 3D sound field created from sources that each have a particular 3D location in space. Ambisonics uses spherical harmonic basis functions to transmit and store 3D audio, in a way that does not map the audio to a specific speaker layout. Ambisonics channels do not correspond to any particular speaker in a speaker setup; instead, each speaker plays audio so that, collectively, the speaker setup approximately recreates the original 3D sound field.

### BRIEF DESCRIPTION OF THE DRAWINGS

FIG. 1 illustrates an example method for compressing Ambisonics signals.

FIG. 2 illustrates an example implementation of the example method of FIG. 1 that uses windowing.

FIG. 3 illustrates an example implementation of the example method of FIG. 1 that does not use frames or windowing.

FIG. 4 illustrates an example implementation of the method of FIG. 1 in which windowing is applied less frequently than in the example implementation of FIG. 2.

FIG. 5 illustrates the difference in frame boundaries used by the different windowing techniques of the implementations of FIGS. 2 and 4.

FIG. 6 illustrates an example computing system.

### DESCRIPTION OF EXAMPLE EMBODIMENTS

Higher Order Ambisonics (HOA) is an immersive spatial encoding technique that uses spherical harmonics coefficients for sound field encoding. These coefficients, in conjunction with spherical harmonics as the basis functions, are combined to approximate the original recorded sound field. Mathematically, for a given radius r, angle θ, and wave number k, the pressure in a plane is represented by the equation below, where Bₘₘ^{±1} denote the HOA coefficients.

$$p ( r , θ ) = {B}_{00}^{+ 1} {J}_{0} ( kr ) + {\sum }_{m = 1}^{∞} {J}_{m} ( kr ) {B}_{mm}^{+ 1} \sqrt{2} cos ( m ∅ ) + {\sum }_{m = 1}^{∞} {J}_{m} ( kr ) {B}_{mm}^{- 1 \sqrt{2}} sin ( m ∅ )$$

To achieve completely accurate reproduction of the original sound field, theoretically an infinite number of spherical harmonics would be needed. However, implementing HOA in a real system requires truncation to a finite order M, where increased order yields enhanced fidelity (although at some point the change in fidelity is not discernable by a human listener). The resultant truncated multichannel HOA signal, known as B-format, requires (M+1)² ambisonics channels to represent the sound field accurately. For instance, first-order ambisonics requires 4 channels, second-order ambisonics requires 9 channels, and third-order ambisonics requires 16 channels. Decoding these channels to speaker signals involves applying a decoding matrix contingent upon the HOA B-format order and speaker positioning.

An important aspect of immersive audio delivery is audio coding, which involves encoding and transmitting audio data in a way that attempts to balance the tradeoffs between perceptual quality and bitrate. That is particularly true for HOA—despite its ability to produce immersive audio environments, HOA poses challenges regarding data compression and transmission. The high channel count inherent in HOA entails substantial bitrate requirements for transmission.

For immersive audio coding, some approaches use proprietary compression tools that are specifically tailored for immersive content. However, such encodings are custom built, and therefore are not widely available and do not integrate with existing open-source techniques, and therefore such approaches suffer from an inability to use existing codecs without substantial adaptations. On the other hand, open source tools exist that are competitive in traditional formats like stereo, but do not provide good quality for immersive audio. For example, the open-source tool Opus projects an Ambisonics signal into a pre-determined channel-based format and then employs joint channel compression. In Opus, temporal psychoacoustic redundancies are exploited in order to compress the signal. However, these channel-mapping techniques do not take advantage of the unique properties of Ambisonics signals, including the significant amount of inter-channel correlations which exist. Thus, for Ambisonics content, existing tools either do not apply decorrelating transforms or naively apply decorrelating transforms without applying adaptive or energy-based bit allocation. This can quickly become computationally expensive in terms of bitrate for high quality Ambisonics.

In contrast, the techniques of this disclosure perform an energy-compacting, spatially decorrelating transform on Ambisonics data, followed by energy-based channel-by-channel allocation of the available bitrate, which can then be used by a legacy mono-channel codec (e.g., Opus) for compressing of each channel separately.

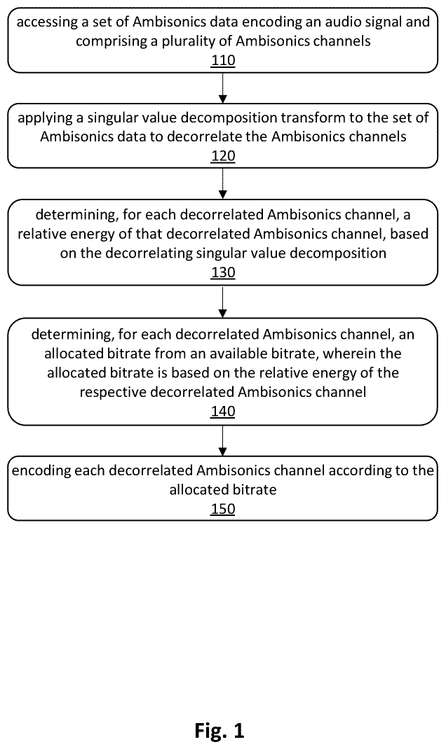

FIG. 1 illustrates an example method for compressing Ambisonics signals. Step 110 of the example method of FIG. 1 includes accessing a set of Ambisonics data encoding an audio signal and including multiple Ambisonics channels. The Ambisonics data accessed in step 110 may be the coefficients of the Ambisonics basis functions that represent the audio signal in the Ambisonics basis. Ambisonics data X may be an L×N matrix that has L time samples and N Ambisonics channels.

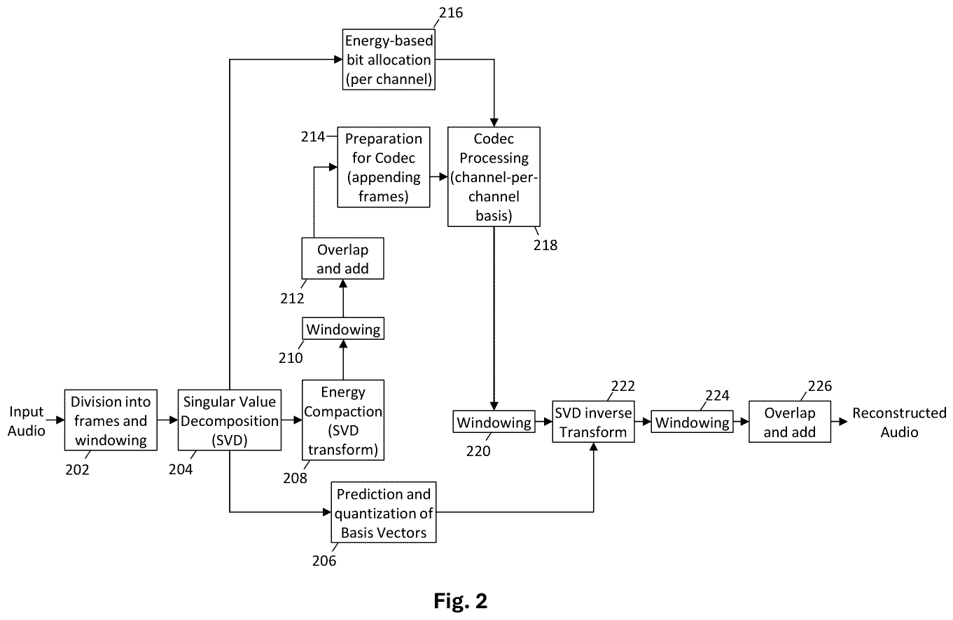

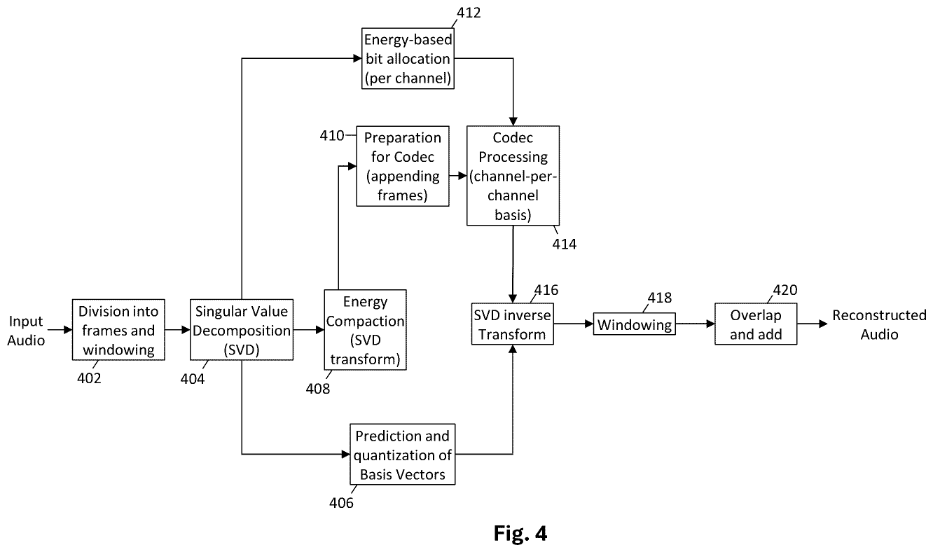

FIG. 2 illustrates an example implementation of the example method of FIG. 1 that uses windowing to correct artifacts due to the spatial transforms, e.g., to smooth blocking artifacts induced on a frame-by-frame basis by the decorrelating transform. As described more fully herein, particular embodiments—such as the example implementations of FIG. 2 and FIG. 4—divide the Ambisonics data X into m frames Xₘ. For instance, the example implementation of FIG. 2 divides the input Ambisonics data into frames and overlapping windows in step 202. The windows may be of length K with an overlapping region of length W that is shared by adjacent frames. In particular embodiments, a square-root Hann window is applied to the overlapping regions before further processing.

Step 120 of the example method of FIG. 1 includes applying a singular value decomposition transform to the set of Ambisonics data to decorrelate the Ambisonics channels. For instance, step 204 of the implementation of FIG. 2 applies a singular value decomposition (SVD) to each frame of Ambisonics data. For a frame-based implementation, the SVD may be represented by:

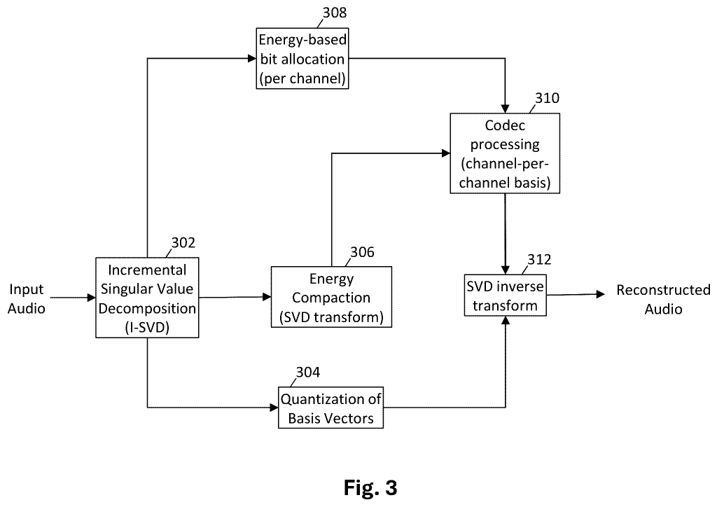

Xₘ=UₘSₘVₘ^{T}

Where Uₘ, Sₘ, and Vₘ are matrices. FIG. 3 illustrates an example implementation of the example method of FIG. 1 that does not use frames or windowing. In the example of FIG. 3, step 302 applies an incremental SVD to the entire set of Ambisonics data X. As explained more fully below, this requires fewer repeat operations than the example implementations of FIGS. 2 and 4 (because various steps do not need to be repeated for each frame, and the windowing preprocessing and postprocessing is avoided), but the decorrelation and energy estimates for encoding channel-specific bitrates may be less accurate, because such techniques are applied on the entire set of data, rather than being tailored to the data in a specific frame.

Audio data in Ambisonics form often contains redundant or correlated information across the Ambisonics channels. By representing the Ambisonics audio data with a singular value decomposition, the data can be represented in the SVD basis, as identified by Vₘ, rather than in the Ambisonics basis as represented by the Ambisonics basis functions, and the decorrelation and bitrate-determines occur in the SVD basis, as explained below.

The basis vectors, Vₘ, contain the directional information associated with a frame of Ambisonics data. Particular embodiments may truncate Vₘ to the first z basis vectors (e.g., the first 8 basis vectors) to generate a truncated basis \hat{V}ₘ. Particular embodiments may preform linear predication and quantization on \hat{V}ₘ by predicting the basis vectors using the last frame of data, for example as illustrated in step 206 of FIG. 2. Quantization is also illustrated in step 304 of the example of FIG. 3 for the basis V (no indexing subscript is used because no frames are used in this implementation). This truncated basis \hat{V}ₘ may then be transmitted to a channel-based, temporal encoder, as described more fully below.

Particular embodiments may compact the channels by applying a transform to the Ambisonics data in the SVD basis:

$${Y}_{m} = {x}_{m} {{\hat{V}}_{m} ( {\hat{V}}_{m}^{T} {\hat{V}}_{m} )}^{- 1}$$

For instance as illustrated in step 208 of FIG. 2 and step 306 of FIG. 3. The purpose of the inverse term is to renormalize the quantized basis vectors in order to maintain unitarity. At step 210, the square-root Hann window is applied to the overlapping regions, and at step 212 the overlapping regions are added together. The decorrelated, compacted Ambisonics data in the SVD basis may have fewer basis vectors (channels) than in the Ambisonics basis of spherical harmonics, and therefore there may not be a 1-to-1 channel correspondence between the original input Ambisonics channels and the representation in the SVD basis.

Step 130 of the example method of FIG. 1 includes determining, for each decorrelated Ambisonics channel, a relative energy of that decorrelated Ambisonics channel, based on the decorrelating singular value decomposition transform, and step 140 includes determining, for each decorrelated Ambisonics channel, an allocated bitrate from an available bitrate, where the allocated bitrate is based on the relative energy of the respective decorrelated Ambisonics channel. The relative energies for the decorrelated Ambisonics channels are determined by the diagonal values of the matrix Sₘ from the singular value decomposition of the Ambisonics audio signal. For instance, each diagonal value of the matrix Sₘ relative to the total sum of the diagonal values of Sₘ define the relative energy for each corresponding decorrelated Ambisonics channel. As discussed herein, this relative energy determination is for channels in the decorrelated Ambisonics domain (i.e., the Ambisonics data in the SVD domain determined by the basis vectors of \hat{V}ₘ), not necessarily for each Ambisonics channel as defined by the distinct the original Ambisonics spherical harmonics basis functions.

For each decorrelated Ambisonics channel, a bitrate for that channel is assigned from a total available bitrate based on the proportional energy of that channel. In other words, a particular decorrelated Ambisonics channel is assigned a percentage of the available bitrate identified by the relative energy percentage of the corresponding diagonal value from Sₘ. For instance, if 30% of the total energy is in a particular diagonal value, then 30% of the available bitrate would be assigned to the corresponding decorrelated Ambisonics channel. In particular embodiments, a predetermined lower and/or upper limit for per-channel bitrates may be used, and step 140 may include an iterative process that determines whether any assigned bitrate to any decorrelated Ambisonics channel violates the upper or lower bitrate limit. If so, then any such channel will be assigned the maximum or minimum bitrate as specified by the upper or lower bitrate limits, respectively, and the remaining bitrates will be adjusted accordingly so that the sum of assigned bitrates to the decorrelated Ambisonics channels equals the total available bitrate. In particular embodiments, the upper and lower bitrate limits may depend on the encoder used, e.g., in step 218. The assigned bitrate for each decorrelated Ambisonics channel is given as a parameter to the encoder. The assigned bitrate is based on the spatial information in the decorrelated Ambisonics channels, and the subsequent relative energies are a good proxy for the importance of the data in each channel. Step 216 of FIG. 2 and step 308 of FIG. 3 illustrate the energy-based bit allocation.

Step 150 of the example method of FIG. 1 includes encoding each decorrelated Ambisonics channel according to the allocated bitrate determined in step 140. Each decorrelated Ambisonics channel can be encoded using a single (mono) channel codec, such as Opus, that compresses an input channel based on the temporal correlations within that channel. Step 310 of the example of FIG. 3 and step 218 of the example of FIG. 2 illustrates an example of this process. As illustrated in the example of FIG. 2, step 214 includes appending the frames of a particular decorrelated Ambisonics channel together prior to sending that channel's frames to the mono-channel encoder, which is part of a codec (e.g., Opus) that encodes and decodes the channels. However, other embodiments (e.g., some real-time embodiments) may simply pass each frame to the codec for encoding/decoding on a frame-by-frame, channel-by-channel basis.

In the example of FIG. 2, after encoding/decoding by the codec, then Yₘ is decoded yielding \tilde{Y}ₘ. Then, the square-root Hann window is applied again (at step 220) at the overlap regions of \tilde{Y}ₘ. An approximation of the original Ambisonics channel Xₘ is then recovered through \tilde{X}ₘ=\tilde{Y}ₘ\hat{V}ₘ^{T}, an inverse SVD transformation applied at step 222 (step 312 of the implementation of FIG. 3). A square-root Hann window is then applied again at the overlap regions, in step 224, before the overlap-add method (step 226) is used across the overlap regions to obtain the final approximation for X. The end result is a reconstructed Ambisonics audio signal in the Ambisonics basis. The signal is compressed by accounting for both spatial redundancies across Ambisonics channels, due to the energy compaction after conversion to the SVD basis, and accounting for temporal redundancies within each decorrelated, SVD-basis Ambisonics channel using a conventional mono-channel codec. In addition, the output Ambisonics data is encoded using bitrate allocations that are determined based on the relative energies associated with the decorrelated Ambisonics channels, in the SVD basis, which is a good proxy for the relative importance of the audio information in each channel. Thus, the output audio signal is compressed and bitrate allocations are intelligently made across channels, while still performing encoding using standard mono-channel encoding techniques.

As mentioned above, the example implementation of FIG. 3 uses incremental SVD without any subdivision into frames on the input Ambisonics data X to yield

X≈USV^{T}

where U, S, and V are approximations for the full SVD decomposition of X, since X is not divided into frames. Truncation of V and generation of compacted channels Y are performed as described above, but again using the full Ambisonics data without framing and windowing. The techniques of FIG. 3 do not divide the data into frames, but may be less accurate than the techniques of FIGS. 2 and 4, because the basis changes, bitrates, and energy compaction are estimated using the full set of data, rather than being tailored to the specific data in each frame.

FIG. 4 illustrates an example implementation of the method of FIG. 1 in which windowing is applied twice, rather than four times as in the example of FIG. 2. In the implementation of FIG. 4, windowing is performed in step 402 when dividing the input Ambisonics audio data into frames. Windowing is likewise applied at step 418 after applying the inverse SVD transformation in step 416. The implementation of FIG. 4 avoids applying the square-root Hann window when the data is in the SVD domain, which may cause issues due to the different sets of basis vectors used by adjacent frames. On the other hand, the implementation of FIG. 4 may have less synchronicity with respect to the original frame boundaries, while the implementation of FIG. 2 maintains these boundaries.

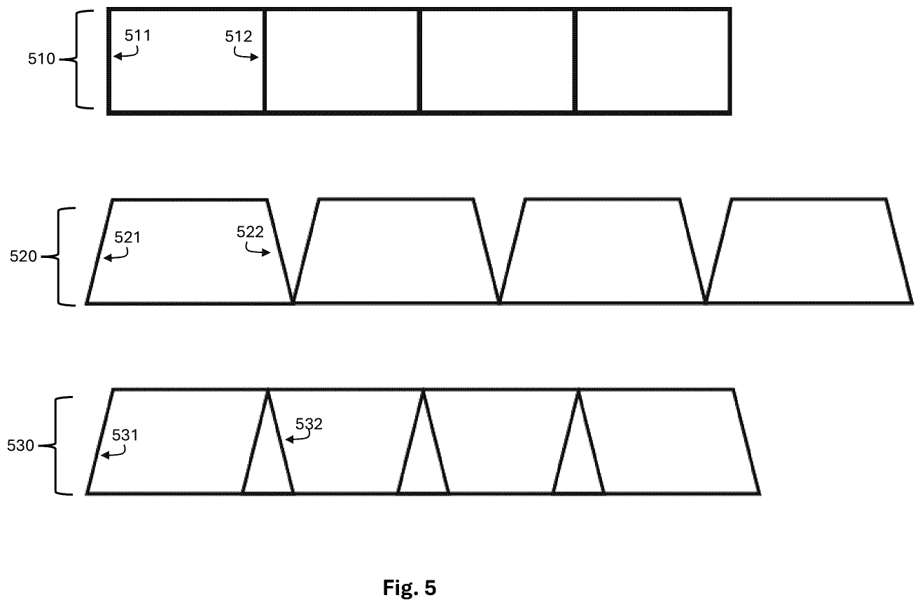

FIG. 5 illustrates the difference in frame boundaries used by the different windowing techniques of the implementations of FIGS. 2 and 4. Original data 510 includes boundaries 511 and 512 at each frame while data 520 for the implementation of FIG. 4 includes boundaries 521 and 522 for each frame and data 530 for the implementation of FIG. 2 includes boundaries 531 and 532 for each frame. The example method of FIG. 2 keeps processing by the codec in synch with the original input audio because the frame boundaries occur in the same place.

The implementation of FIG. 4 is otherwise similar to that of FIG. 2: singular value decomposition is applied in step 404, predication and quantization occurs in step 406, energy compaction occurs in step 408, appending frames occurs in step 410, and the codec processing occurs in step 414, which uses the energy-based bit allocations determined in step 412 to determine the bitrate for each decorrelated channel. The inverse SVD transform is applied in step 416, followed by windowing in step 418 and overlap and add in step 420 to recreate the input audio signal.

The techniques described herein provide spatial compression and intelligent bit-rate allocation for immersive Ambisonics audio data, while also integrating with standard mono-channel encoders, providing for efficient compaction and transmission of immersive audio data. In addition, the techniques described herein do not require the resources of an end-to-end proprietary compression and encoding technique for immersive audio, and instead standard mono-channel encoders (e.g., Opus) can be used.

In particular embodiments, the SVD approaches described above may be altered in the presence of noise (e.g., for a live broadcast) by using the kernel-based SVD/PCA approaches described below. The noise captured by an Ambisonics microphone may first be classified by a machine learning noise classifier. Accordingly, the best kernel for a kernel-PCA is then selected based on the noise profile and the noise power, where a priori optimization of the kernel type and kernel parameters are done using a signal plus noise model.

For-PCA, the choice of kernel is determined during training-phase (offline) using stochastic optimization techniques (e.g., Bayesian optimization, simulated annealing, etc.). Instead of standard SVD techniques, kernel-PCA would be used during deployment and the kernel type and kernel parameters would be transmitted as metadata for the given frame.

During the training phase, the optimization of the kernel-PCA for a given frame may be done using Bayesian optimization by minimizing the MSE (dB) between the reconstructed signal \hat{X} for each channel and the original signal X (in the presence of noise—signal plus noise model), where N is the number of Ambisonics channels. The noise can be acquired in the first few milliseconds when the Ambisonics microphone is setup for live transmission.

$$MSE ( dB ) = 10 {log}_{10} ( \frac{1}{N} ) {\sum }_{i = 1}^{N} {\vert \underline{X} - \underline{\hat{X}} \vert}^{2}$$

Bayesian optimization is a global hyper-parameter optimization technique, constrained on the bounds of the hyper-parameters, and may be best suited for optimization with 20 or fewer hyper-parameters. The method builds a surrogate function for the objective and quantifies the uncertainty in that surrogate using Gaussian process regression. Additionally, several parameters are required for initialization, including the type of acquisition function which guides the sampling for the optimal hyper-parameters. In particular embodiments, hyper-parameters may include: (i) kernel type, and (ii) corresponding kernel parameters.

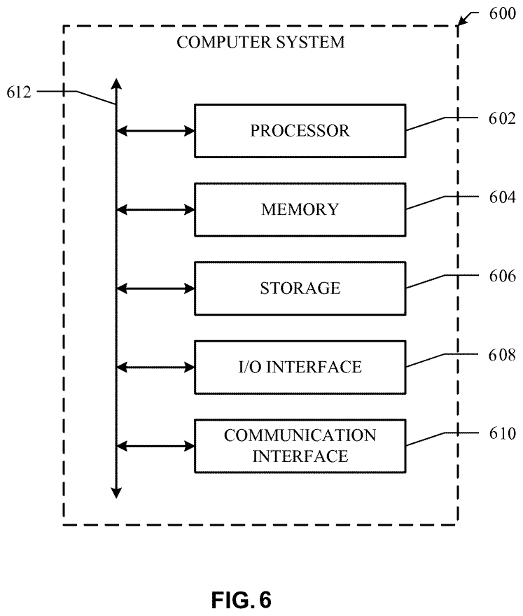

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing a set of Ambisonics data encoding an audio signal and comprising a plurality of Ambisonics channels;
applying a singular value decomposition transform to the set of Ambisonics data to decorrelate the Ambisonics channels;
determining, for each decorrelated Ambisonics channel, a relative energy of that decorrelated Ambisonics channel, based on the decorrelating singular value decomposition transform; and
determining, for each decorrelated Ambisonics channel, an allocated bitrate from an available bitrate, wherein the allocated bitrate is based on the relative energy of the respective decorrelated Ambisonics channel; and
encoding each decorrelated Ambisonics channel according to the allocated bitrate.

2. The method of claim 1, further comprising compressing one or more decorrelated Ambisonics channels by truncating a set of basis vectors from the singular value decomposition.

3. The method of claim 1, further comprising adjusting one or more of the allocated bitrates based on one or more of a minimum bitrate threshold or a maximum bitrate threshold.

4. The method of claim 1, further comprising dividing the accessed set of Ambisonics data into a plurality of frames.

5. The method of claim 4, further comprising creating an overlapping window of data between each pair of adjacent frames.

6. The method of claim 1, further comprising applying an inverse singular value decomposition transformation to the encoded decorrelated Ambisonics channels.

7. The method of claim 1, wherein the singular value decomposition comprises an incremental singular value decomposition.

8. One or more non-transitory computer readable storage media storing instructions that are operable when executed to:
access a set of Ambisonics data encoding an audio signal and comprising a plurality of Ambisonics channels;
apply a singular value decomposition transform to the set of Ambisonics data to decorrelate the Ambisonics channels;
determine, for each decorrelated Ambisonics channel, a relative energy of that decorrelated Ambisonics channel, based on the decorrelating singular value decomposition transform; and
determine, for each decorrelated Ambisonics channel, an allocated bitrate from an available bitrate, wherein the allocated bitrate is based on the relative energy of the respective decorrelated Ambisonics channel; and
encode each decorrelated Ambisonics channel according to the allocated bitrate.

9. The media of claim 8, wherein the instructions are further operable when executed to compress one or more decorrelated Ambisonics channels by truncating a set of basis vectors from the singular value decomposition.

10. The media of claim 8, wherein the instructions are further operable when executed to adjust one or more of the allocated bitrates based on one or more of a minimum bitrate threshold or a maximum bitrate threshold.

11. The media of claim 8, wherein the instructions are further operable when executed to divide the accessed set of Ambisonics data into a plurality of frames.

12. The media of claim 11, wherein the instructions are further operable when executed to create an overlapping window of data between each pair of adjacent frames.

13. The media of claim 8, wherein the instructions are further operable when executed to apply an inverse singular value decomposition transformation to the encoded decorrelated Ambisonics channels.

14. The media of claim 8, wherein the singular value decomposition comprises an incremental singular value decomposition.

15. A system comprising:
one or more non-transitory computer readable storage media storing instructions; and one or more processors coupled to the one or more non-transitory computer readable storage media and operable to execute the instructions to:
access a set of Ambisonics data encoding an audio signal and comprising a plurality of Ambisonics channels;
apply a singular value decomposition transform to the set of Ambisonics data to decorrelate the Ambisonics channels;
determine, for each decorrelated Ambisonics channel, a relative energy of that decorrelated Ambisonics channel, based on the decorrelating singular value decomposition transform; and
determine, for each decorrelated Ambisonics channel, an allocated bitrate from an available bitrate, wherein the allocated bitrate is based on the relative energy of the respective decorrelated Ambisonics channel; and
encode each decorrelated Ambisonics channel according to the allocated bitrate.

16. The system of claim 15, further comprising one or more processors that are operable to execute the instructions to compress one or more decorrelated Ambisonics channels by truncating a set of basis vectors from the singular value decomposition.

17. The system of claim 15, further comprising one or more processors that are operable to execute the instructions to adjust one or more of the allocated bitrates based on one or more of a minimum bitrate threshold or a maximum bitrate threshold.

18. The system of claim 15, further comprising one or more processors that are operable to execute the instructions to divide the accessed set of Ambisonics data into a plurality of frames.

19. The system of claim 18, further comprising one or more processors that are operable to execute the instructions to create an overlapping window of data between each pair of adjacent frames.

20. The system of claim 15, further comprising one or more processors that are operable to execute the instructions to apply an inverse singular value decomposition transformation to the encoded decorrelated Ambisonics channels.
